(19) United States
(12) Patent Application Publication
(10) Pub. No.: US 2008/0067187 A1
(43) Pub. Date: Mar. 20, 2008

(54) Under the Counter Beverage Cooler

(75) Inventors: Arthur G. Rudick, Atlanta, GA (US); Lenoard F. Antao, Smyrna, GA (US); David Harvey, Suwanee, GA (US); Thomas P. Howell, Suwanee, GA (US); Jonathan A. Kirschner, Powder Springs, GA (US); Daniel Robert Peters, Alpharetta, GA (US); Guy Primiano, Alpharetta, GA (US)

Correspondence Address: SUTHERLAND ASBILL & BRENNAN LLP, 999 PEACHTREE STREET, N.E., ATLANTA, GA, 30309, US

(73) Assignee: THE COCA-COLA COMPANY, Atlanta, GA (US)

(21) Appl. No.: 11/469,493

(22) Filed: Sep. 1, 2006

(51) Int. Cl. G07F 11/00

(52) U.S. Cl. 221/123

(57) ABSTRACT

A container for use with a number of products. The container may include a product storage area, a product delivery system with a product platform, and a product display area with at least one product gate.

### TECHNICAL FIELD

The present application relates generally to containers such as coolers or refrigerators and more particularly relates to a container with an under the counter storage compartment and a related delivery system.

### BACKGROUND OF THE INVENTION

In many retail outlets, countertop space represents premium real estate. The proprietor of the outlet often desires to offer as many products as may be possible on the countertop while keeping the more popular or the impulse buy products within eyesight and easy reach of the consumer. Whether to place a product on the countertop and where to place a product on the countertop can have a significant impact on the sales of such a product.

A small cooler such as a glass door merchandiser can be placed on the countertop and filled with beverages such as soft drinks, sports drinks, waters, teas, coffees, etc. Such a glass door merchandiser, however, generally holds a relatively small number of products for its size. In other words, the glass door merchandiser also has a relatively large footprint given the need for the refrigeration unit and other types of typical components. The glass door merchandiser also should be restocked frequently so as to have an ample supply of the products always available for the consumer.

There is a desire therefore for a countertop cooler that has a smaller footprint than known devices. There is a further desire for a countertop cooler that automatically stays well stocked. These desires should be met in a cooler that is reasonably priced and reasonably easy to use.

### SUMMARY OF THE INVENTION

The present application thus describes a container for use with a number of products. The container may include a product storage area, a product delivery system with a product platform, and a product display area with at least one product gate.

The container further may include a countertop such that the product storage area is positioned beneath the countertop and the product display area is positioned above the countertop. The product storage system may include an insulated cabinet with a number of storage shelves. The storage shelves may include gravity fed shelves. The product delivery system may include a pulley system so as to maneuver the product platform. The pulley system may include a number of pulleys and a number of belts connected to a double shaft motor.

The product platform may include a number of fins positioned thereon. The product gate may include a number of tines spaced so as to allow the fins to pass therethrough. The product display area may include a number of glass panels. The glass panels define an unobstructed opening. The container further may include a sensor positioned about the product display area.

The present application further describes a method of providing products to a consumer. The method may include displaying a number of the products on at least one product gate in a product display area, sensing the removal of one of the products from the product display area, activating a product delivery system, elevating a replacement product through the product gate via the product delivery system, and deactivating the product delivery system.

The present application further describes a container for use with a number of products. The container may include an insulated cabinet, a product platform, a pulley system to drive the product platform, and a product display area with at least one product gate such that the product platform can pass therethrough.

The insulated cabinet may include a number of storage shelves. The storage shelves may include gravity fed shelves. The product platform may include a number of fins positioned thereon. The product gate may include a number of tines spaced so as to allow the fins to pass therethrough. The container further may include a sensor positioned about the product display area.

These and other features of the present application will become apparent to one of ordinary skill in the art upon review of the following detailed description when taken into conjunction with the drawings and the appended claims.

### BRIEF DESCRIPTION OF THE DRAWINGS

FIG. 1 is a perspective view of an under the counter cooler as is described herein.

FIG. 2 is a side cross-sectional view of the cooler of FIG. 1.

FIG. 3 is a side cross-sectional view of several components of the product delivery system of the cooler FIG. 1.

FIG. 4 is a perspective view of several of the components of the product delivery system of FIG. 1.

FIG. 5 is a perspective view of a product delivery platform.

FIG. 6 is a top cross-sectional view of the product display area.

FIGS. 7A-7C are side cross-sectional views of a product being delivered to the product display area.

### DETAILED DESCRIPTION

The methods and devices described herein are intended to be used with a number of products 10. Although the products 10 shown herein are in the form of beverage bottles 20, the products 10 may be any item that may be stored within a container. The methods and devices described herein may be used with refrigerated or non-refrigerated products. The beverage bottles 20 shown herein may contain any type of fluid, such as carbonated soft drinks, sports drinks, energy drinks, waters, teas, milks, coffees, juices, and the like. The present application is not limited to the type of product 10 used herein.

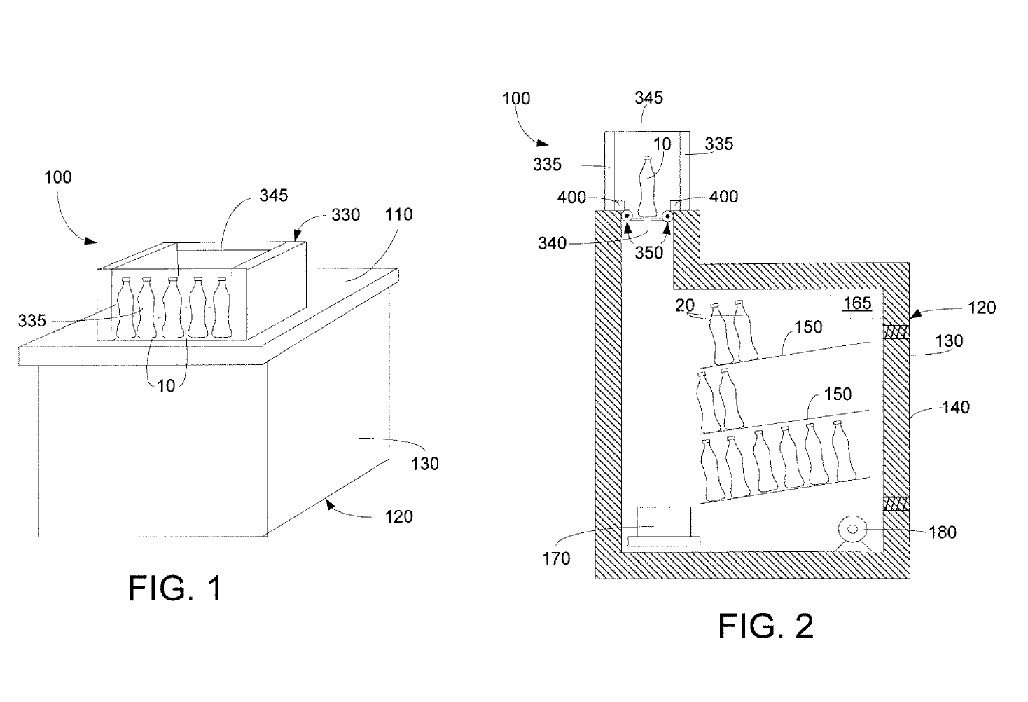

Referring now to the drawings, in which like numerals refer to like elements throughout the several views, FIG. 1 shows an under the counter cooler 100 as is described herein. As is shown, portions of the cooler 100 are positioned above a countertop 110 and portions of the cooler 100 are positioned below the countertop 110. Any other configuration may be used herein. The countertop 110 may be part of an existing countertop or the countertop 110 may be incorporated into the overall cooler 100 and installed therewith. The countertop 110 may be made out of any convenient type of material.

The under the counter cooler 100 includes a product storage system 120. As is shown in FIG. 2, the product storage system 120 may be positioned in large part beneath the countertop 110. The product storage system 120 may include an insulated cabinet 130 with an insulated door 140. The insulated cabinet 130 and the insulated door 140 may take any desired size or shape.

Positioned within the insulated cabinet 130 may be a number of product storage shelves 150. The product storage shelves 150 may be positioned at an angle so as to provide a gravity fed effect. Specifically, the product storage shelves 150 may dispense a product 10 as will be described in more detail below under the force of gravity. Any other type of dispensing mechanism may be used with the product storage shelves 150. For example, the shelves 150 may contain mechanical feed assist mechanisms (not shown) such as those found on shelves of vending machines sold by Dixie Narco of Williston, S.C. under the designation “DN 5000 Glass Front Vendor”. The number of facings or individual storage slots on each of the product storage shelves 150 should be the same as the number of product positions as will be explained in more detail below.

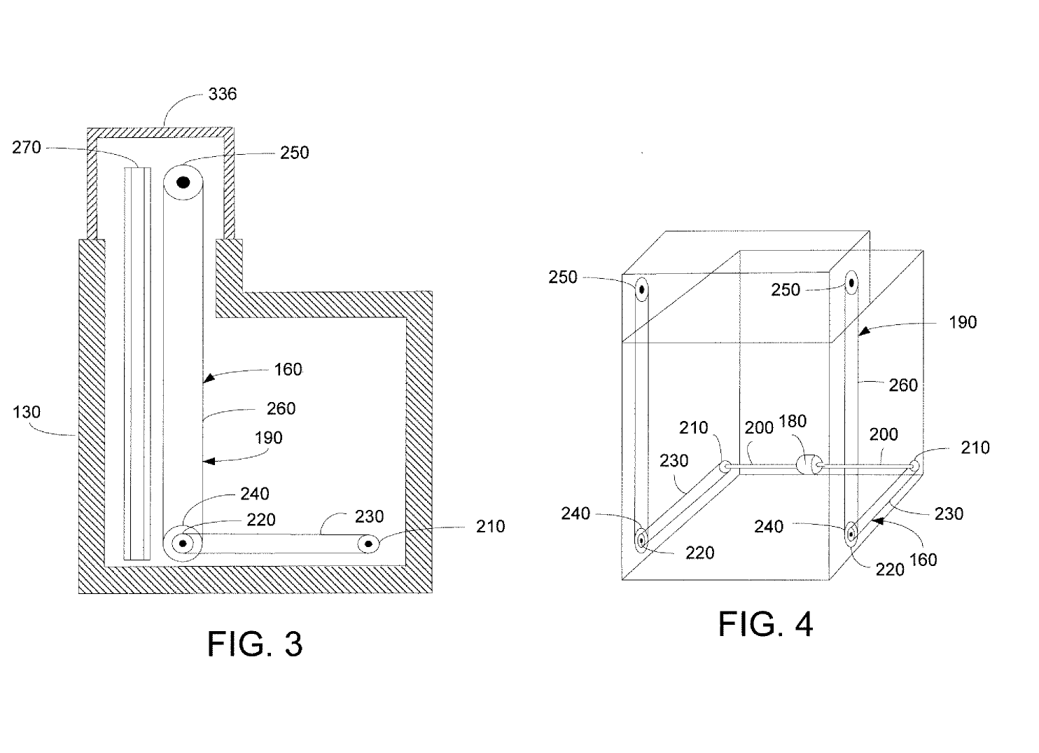

The under the counter cooler 100 further includes a product delivery system 160. As is shown in FIGS. 2-4, the product delivery system 160 may be positioned within the insulated cabinet 130 adjacent to the product storage shelves 150. The product delivery system may be operated by a conventional control system 165.

The product delivery system 160 includes a product delivery platform 170. The product delivery platform 170 is described in more detail below. A motor 180 and a pulley system 190 may drive the product delivery platform 170. The motor 180 may be a double shaft motor with shaft ends 200 extending on either side. Similar designs and similar types of motors may be used herein. The shafts 200 may be connected to a first set of pulleys 210. The first set of pulleys 210 is connected to a second set of pulleys 220 by a pair of horizontal belts 230. The second set of pulleys 220 is directly connected to a third set of pulleys 240. The third set of pulleys 240 is connected to a fourth set of pulleys 250 via a vertical belt 260. The vertical belts 260 drive the product delivery platform 170 up and down as may be desired. The platform 170 may be positioned within a set of drive tracks 270. Although the product delivery system 160 has been described in detail with respect to the belt and pulley system 190, any type of elevation or drive system may be used herein.

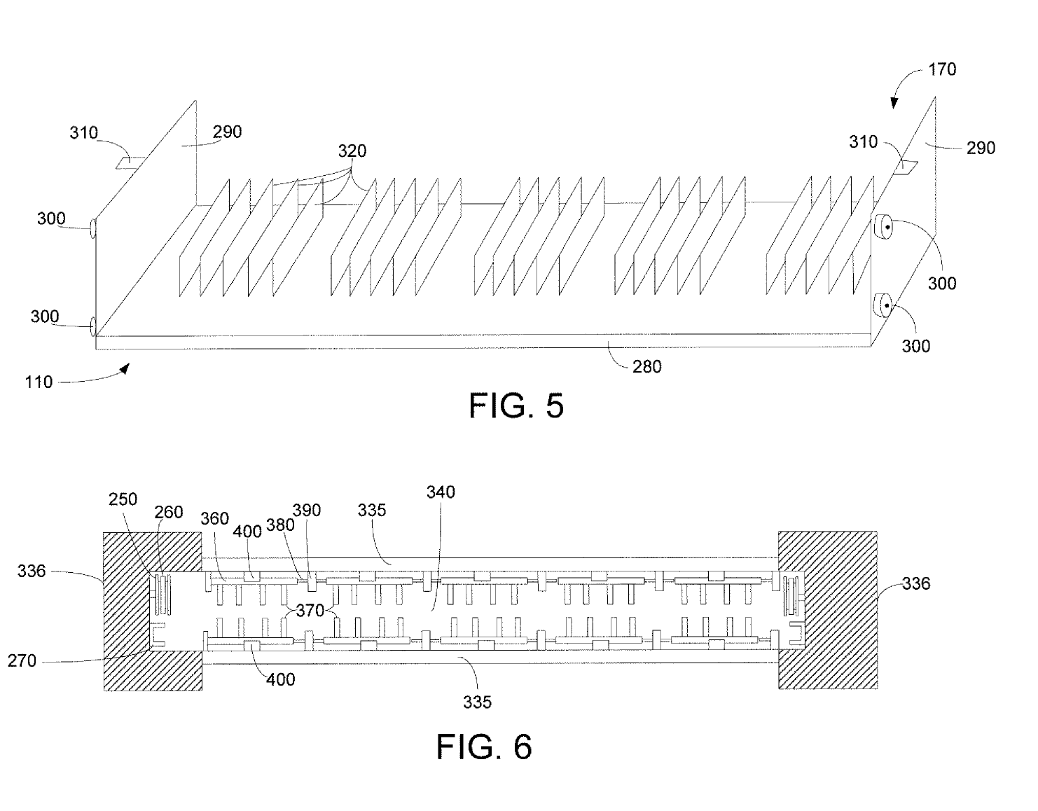

The product delivery platform 170 may include a base plate 280. The base plate 280 may be made out of any type of substantially non-corrosive material. As is shown in FIG. 5, two end plates 290 may be positioned on either side of the base plate 280. A number of guide wheels 300 may be positioned on the end plates 290 so as to travel along the drive track 270. The end plates 290 further may include an attachment flange 310. The flange 310 may be used to connect the platform 170 to the vertical drive belt 260. Any similar type of connection elements may be used herein so as to maneuver the platform 170.

The platform 170 may include a number of vertical fins 320 positioned thereon. The fins 320 may be positioned within a number of groups. The groups may relate to a number of product positions in the product storage system 120. The fins 320 also may be made out of a substantially non-corrosive material.

The under the counter cooler 100 further may include a product display area 330. The product display area 330 may be positioned largely on top of the countertop 110 and may be in communication with the product delivery system 160 via an aperture 340 within the countertop 110. The aperture 340 allows the product delivery system 160 in general, and the platform 170 in specific, to extend from the insulated cabinet 130 to the product display area 330. The product display area 330 may have a number of insulated glass panels 335 surrounding the aperture 340. Other types of substantially transparent materials may be used herein such that consumers can see the products 10 positioned within the product display area 330. The panels 335 also define an opening 345 through which the products 10 may be accessible to the consumer. A pair of brackets 336 may support the panels 335.

As is shown in FIG. 6, the product display area 330 may include at least one product gate 350 positioned about the aperture 340. Each product gate 350 may include a shaft 360 and a number of tines 370. The shaft 360 may pivot about a rod 380. The rod 380 may be held by a number of brackets 390. A number of product gates 350 may be arranged in opposing pairs across the aperture 340. The product gates 350 may be able to pivot about the rod 380 to about ninety (90) degrees or so above the horizontal when a product 10 passes therethrough. The product gates 350 may return to the horizontal either by the force of gravity or they may receive a slight bias towards the horizontal from a torsional spring (not shown). The product gates 350 generally do not pivot below the horizontal.

The fins 320 of the platform 170 fit between the tines 370 of the product gates 350 when the platform 170 extends to its top position. A pair of sensors 400 may be located about the product gates 350 to detect the presence of the products 10 on the product gates 350. The sensors 400 may be photoelectric sensors, contact sensors, or similar types of devices, The sensors 400 may be in communication with the control system 165.

In use, a product 10 may be located in each product position in the product display area 330. The sensors 400 may detect this positioning such that the product delivery system 160 is idle. When a consumer reaches through the opening 345 and removes one of the products 10, the sensors 400 detect the removal. The control system 165 may track how many replacement products remain in each row of the product storage shelves 150. The control system 165 then may direct the product delivery platform 170 to a product storage shelf 150 with the products 10 thereon. A replacement product 10 is then deposited vertically onto the fins 320 of the platform 170.

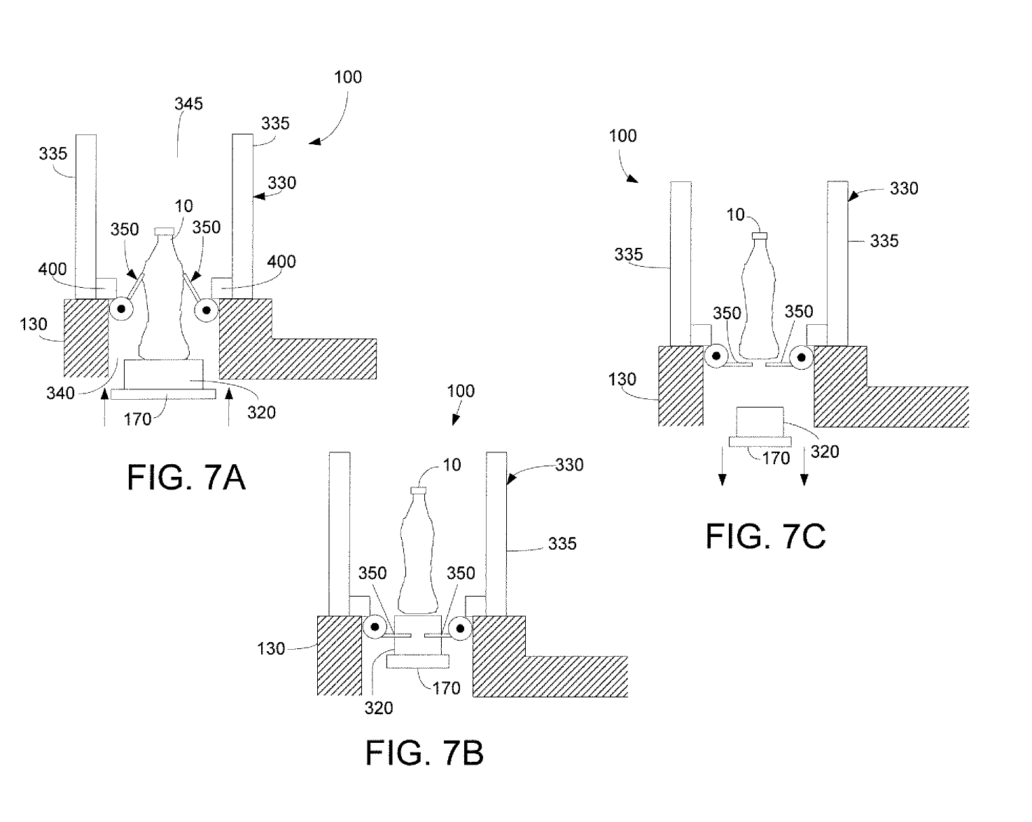

As is shown in FIGS. 7A-C, the motor 180 and the pulley system 190 elevate the product delivery platform 170 with the product 10 thereon. The product 10 passes through the product gates 350. Once the product 10 clears the product gates 350, the gates 350 snap back to the horizontal position. The product 10 is still elevated by the fins 320 of the platform 170. The platform 170 is then again lowered and is no longer visible in the product display area 330. The product 10 then rests on the product gates 350. The sensors 400 again detect the presence of the product 10 such that the product delivery system 160 remains idle until another product 10 is removed from the product gates 350.

The product display area 330 generally may remain unenclosed. The opening 345 at the top of the glass panels 335 allows the consumer easy access to the products 10 therein. Although cold air from the product storage system 120 will enter the product display area 330 through the aperture 340, the cold air will tend to stratify downward away from the opening 345 because the opening 345 is horizontal. This positioning will tend to minimize or eliminate the need for a lid or other enclosure about the opening 345 while maintaining the overall efficiency of the under the counter cooler 100 as a whole. A hinged lid also could be used to minimize further any heat loss through the opening 345.

When the product storage system 120 needs to be reloaded, the door 140 may be opened from behind the sales counter. New products 10 can to be loaded in the back of the product storage shelves 150 so as to provide first in, first out product rotation. Any other type of loading techniques may be used herein.

The under the counter cooler 100 thus provides an attractive and efficient means for presenting products 10 to consumers while limiting the amount of required countertop space. The under the counter cooler 100 may be a retrofit or may be part of original equipment.

It should be apparent that the foregoing relates only to certain embodiments of the present application and that numerous changes and modifications made be made herein by one of ordinary skill in the art without departing from the general spirit and scope of the invention as defined by the following claims and the equivalents thereof.

We claim:

1. A container for use with a number of products, comprising:
a product storage area;
a product delivery system;
the product delivery system comprising a product platform; and
a product display area;
the product display area comprising at least one product gate.

2. The container of claim i, further comprising a countertop such that the product storage area is positioned beneath the countertop and the product display area is positioned above the countertop.

3. The container of claim 1, wherein the product storage system comprises an insulated cabinet.

4. The container of claim 1, wherein the product storage system comprises a plurality of storage shelves.

5. The container of claim 4, wherein the plurality of storage shelves comprises a plurality of gravity fed shelves.

6. The container of claim 1, wherein the product delivery system comprises a pulley system so as to maneuver the product platform.

7. The container of claim 6, wherein the product delivery system comprises a double shaft motor connected to the pulley system.

8. The container of claim 6, wherein the pulley system comprises a plurality of pulleys and a plurality of belts.

9. The container of claim 1, wherein the product platform comprises a plurality of fins positioned thereon.

10. The container of claim 9, wherein the at least one product gate comprises a plurality of tines spaced so as to allow the plurality of fins to pass therethrough.

11. The container of claim 1, wherein the product display area comprises a plurality of glass panels.

12. The container of claim 11, wherein the plurality of glass panels define an unobstructed opening.

13. The container of claim 1, further comprising a sensor positioned about the product display area.

14. A method of providing products to a consumer, comprising:
displaying at least one of the products on at least one product gate in a product display area;
sensing the removal of one of the products from the product display area;
activating a product delivery system;
elevating a replacement product through the at least one product gate via the product delivery system; and
deactivating the product delivery system.

15. A container for use with a number of products, comprising:
an insulated cabinet;
a product platform;
a pulley system to drive the product platform; and
a product display area;
the product display area comprising at least one product gate such that the product platform can pass therethrough.

16. The container of claim 15, wherein the insulated cabinet comprises a plurality of storage shelves,

17. The container of claim 16, wherein the plurality of storage shelves comprises a plurality of gravity fed shelves.

18. The container of claim 15, wherein the product platform comprises a plurality of fins positioned thereon.

19. The container of claim 18, wherein the at least one product gate comprises a plurality of tines spaced so as to allow the plurality of fins to pass therethrough.

20. The container of claim 15, further comprising a sensor positioned about the product display area.
